(19) United States
(12) Patent Application Publication
(10) Pub. No.: US 2013/0065655 A1
(43) Pub. Date: Mar. 14, 2013

(54) Simulation platform for planned athletic plays

(71) Applicant: Errol M. King, New York, NY (US)

(72) Inventor: Errol M. King, New York, NY (US)

(73) Assignee: MVP IQ, Inc., Lewes, DE (US)

(21) Appl. No.: 13/605,292

(22) Filed: Sep. 6, 2012

Related U.S. Application Data
(60) Provisional application No. 61/532,609, filed on Sep. 9, 2011.

(51) Int. Cl. A63F 13/06

(52) U.S. Cl. 463/2

(57) ABSTRACT

Various embodiments relate to a method and related apparatus that simulates planned athletic plays. A device such as a touchscreen tablet or mobile device can use a simulation platform that produces a visualization of one or more athletes in a planned scenario. The platform can then display and/or animate the one or more athletes as they progress through multiple stages of a simulated athletic play. The simulated athletic play can be edited, saved, and sent to other devices, which may also play back the simulated athletic play. In some embodiments, a user can capture video or load saved video clips and associate such videos with the simulated athletic play or steps comprising part of the simulated athletic play. In some embodiments, a user can pause a simulated athletic play during playback to add and edit steps that comprise the play.

### CROSS-REFERENCE TO RELATED APPLICATIONS

This application claims the benefit of any priority to U.S. Provisional Application No. 61/532,609, filed Sep. 9, 2011, which is owned by the assignee of interest an in its entirety incorporated herein.

### TECHNICAL FIELD

The subject matter relates generally to a graphical simulation platform, and more particularly, to a graphical simulation platform on a mobile device.

### BACKGROUND

In many modern sports, including team sports such as basketball, football, and hockey, players can run planned “set” plays, in efforts to maximize opportunities to achieve specific strategic goals. In many instances, coaches illustrate these planned, designed plays on chalkboards or clipboards during practice or stoppages in play. Coaches use such illustrations to convey the relative spacing and movement of the players over the course of the play in abstract terms, similar to illustrations of choreographed dance movements.

While such illustrations of choreographed plays are effective in illustrating relatively simple movements on an athletic playing field, such methods are not as effective when attempting to illustrate complex plays, or plays involving a large amount of movement or dependent steps.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will following the later sections.

Various embodiments relate to a simulation platform for designing and illustrating plays for athletic competitions. The simulation platform can run on a mobile device, such as an iPad, iPhone, or other tablet device with a touchscreen. The simulation platform can allow a user to illustrate athletic plays using an “electronic” whiteboard. The simulation platform can animate multiple players and/or athletic equipment simultaneously, enabling depictions of complex athletic plays involving a large number of players. In some embodiments, the user can illustrate plays using only a subset of players (“relevant players”) that are actually important to the set athletic play. The user can pause and edit athletic plays on the fly, while the simulation platform can reconfigure the positioning and movement to accommodate the user's changes. The user can share configured plays via a server that can share plays as they are updated in real time. In addition, the simulation platform can animate a user-designed play based on player attributes that calculate the likelihood a play, as designed, would be successful.

Various embodiments relate to a method executed on a simulation platform to represent an athletic play. The simulation platform produces a simulated athletic play representing the athletic play by receiving an inputted information representing the athletic play created by a user, producing a first stage comprising a first virtual athlete in a virtual playing environment based on the received inputted information, positioning the first virtual athlete within the virtual playing environment during the first stage, producing a second stage comprising the virtual athlete in the virtual playing environment, and creating a first movement vector representing a change in position of the first virtual athlete between the first stage and the second stage.

In other examples, any of the aspects above can include one or more of the following features. In some embodiments, the method can further include the simulated platform playing the simulated athletic play where the first virtual athlete moves along the first movement vector between the first and second stage. In some embodiments, the simulation platform can also pause the simulated athletic play during the pausing step and changes the first movement vector of the first virtual athlete.

In some embodiments, the simulated platform saves the athletic play. In some embodiments, the simulated platform uploads a saved athletic play to a server. The server also transmits the saved simulated athletic play to at least one other authorized electronic device. In some embodiments, the simulated platform, when creating the simulated athletic play step, establishes possession of athletic equipment by the first virtual athlete or a second virtual athlete in the first stage and creating a possession vector for the athletic equipment.

### BRIEF DESCRIPTION OF THE DRAWINGS

In order to better understand various exemplary embodiments, reference is made to accompanying drawings, wherein:

FIG. 1 illustrates an exemplary simulation platform;

FIG. 2 illustrates another view of the exemplary simulation platform;

FIG. 3 illustrates an exemplary flowchart for control of the viewing playing environment;

FIG. 4 illustrates another part of the exemplary flowchart for control of the viewing playing environment;

FIG. 5 illustrates an exemplary flowchart of editing a loaded athletic play; and

FIG. 6 illustrates an exemplary flowchart of the simulation platform sharing plays.

### DETAILED DESCRIPTION

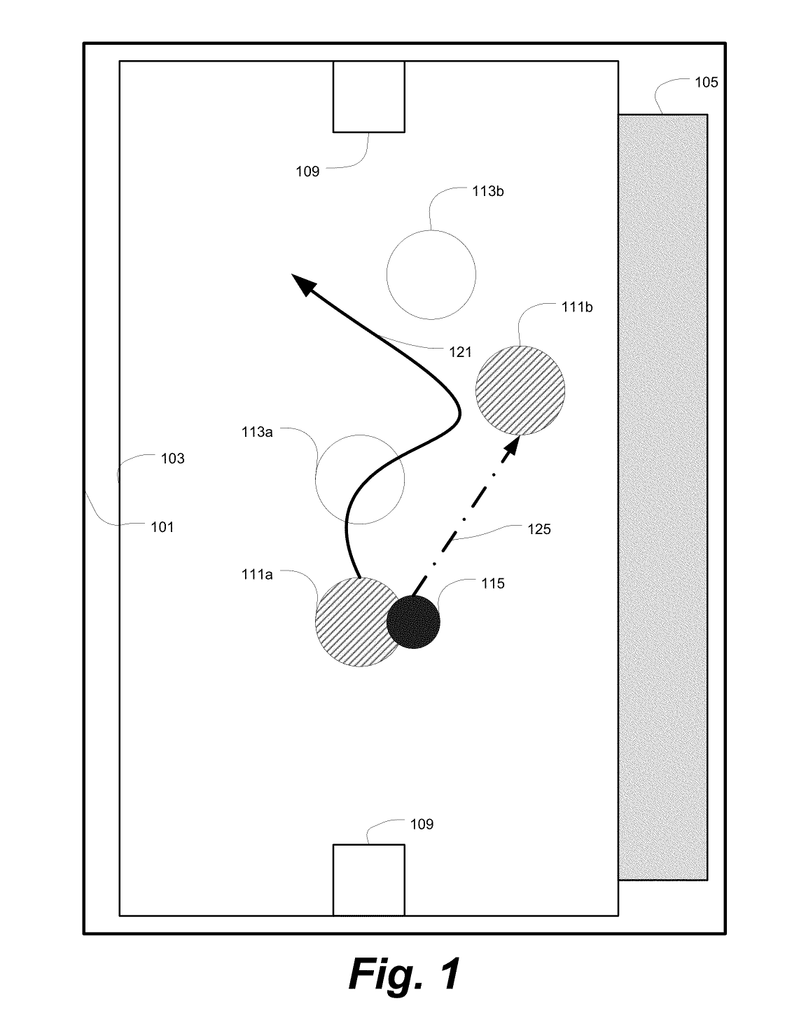

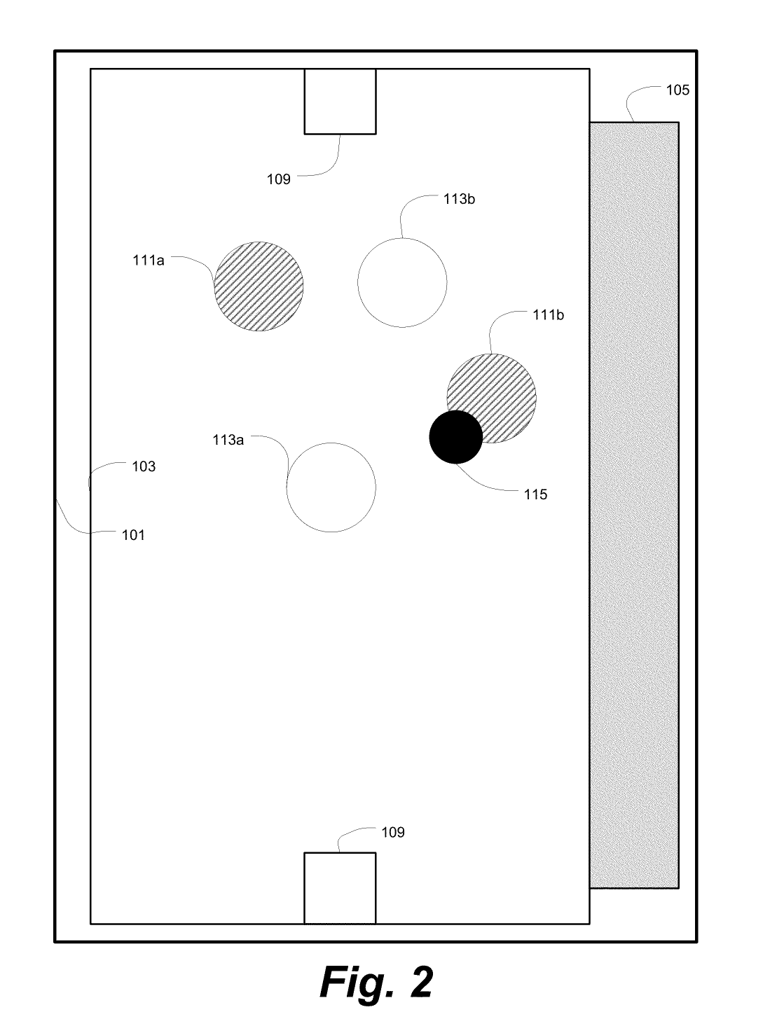

FIGS. 1 and 2 show an embodiment of the simulation platform 101, including a virtual playing environment 103 and a control menu 105. The virtual playing environment (VPE) 103 can include goals 109, team players 111a-111b, opponent players 113a-113b, and athletic equipment 115. The VPE 103 can be configured based on the specific sport played. For example, when illustrating a set play for basketball, the VPE can comprise a half-sized (“half-court”) or full-sized (“full-court”) basketball court. The goals 109, athletic equipment 115, and team and opponent players 111a-111b, 113a-113b can also be configured based on the specific sport and the specific situation. For example, in some embodiments, the team players can 111a-111b be on offense and maintain possession of the athletic equipment 115, while the opponent players 113a-113b can be on defense.

In some embodiments, there can be a different quantity of team players 111a-b than opponent players 113a-113b. This occurs, for example, in set plays that involve different quantities of team players 111a-111b and opponent players 113a-113b, such as during a power play in hockey, or even a give-and-go set play in basketball. The athletic equipment 115 can be based on the type of VPE 103. For example, the athletic equipment 115 represents a basketball when the VPE 103 represents a basketball court. Similarly, when the VPE 103 represents a hockey rink, the athletic equipment 115 can be a hockey puck.

The user can directly control components within the VPE 103, including the team players 111a-111b, the opponent players 113a-113b, and the athletic equipment 115. In a specific stage, any of the players 111a-111b, 113a-113b can be positioned within the VPE 103. In some embodiments, the user moves the players 111a-111b, 113a-113b within the VPE 103. The simulation platform 101 can be implemented on an electronic device with a touchscreen, such as a tablet computer. In such instances, the user can use his or her finger and/or a stylus to directly select a player 111a-111b, 113a-113b by touching the applicable area on the touchscreen and dragging the player to a specific location. Similarly, the user can establish a specific player 111a to have possession of the athletic equipment.

The user can also establish multiple stages of a set play within the VPE 103. As shown in FIG. 1, the user can establish a movement vector for one or more of the players 111a-111b for a particular stage. When going from the initial stage to the next stage, all the players 111a with an associated movement vector 121 traverse along the movement vector until the player 111a reaches the end position at the next stage. For example, as shown in FIGS. 1-2, the user draws the movement vector for the team player 111a in the initial stage. The user can select the appropriate “move” option in the control panel 105 and drag the team player 111a along the path. In some embodiments, the user creates the movement vector 121 by creating a movement arrow within the initial stage. Once the movement vector 121 is established, playback of the simulated athletic play includes an animation of the transition between the initial stage and the next stage (illustrated in FIG. 2). During the transition, the team player 111a travels along the established movement vector 121 until the team player 111a reaches its end position at the end of the movement vector 121. From this next stage, another movement vector (not shown) can be drawn by the user for the team player 111a and other players 111b, 113a-b. In such instances, a subsequent stage exists, with the players transitioning their position from their placement in the next stage (FIG. 2) to their placement in the subsequent stage.

Similarly, the user can establish a possession vector 125 for the athletic equipment 115. In some instances, the user can establish a possession vector 125 by simply selecting the athletic equipment 115 and then selecting the target player 111b or goal 109. When the user selects a target player 111b, as shown in FIG. 1, the simulation platform 101 creates the possession vector 125 between the team player 111a and the team player 111b. In other instances, the user's selection of the goal 109 creates a possession vector 125 and the goal 109. This possession vector 125 can signify a shot on goal by the team player 111a. In some instances, the user can select a specific area on the VPE 103 as an endpoint for the possession vector 125. A user can implement such a possession vector 125 to illustrate plays where the player 111b has not yet arrived to the area, but will be in that position in the next stage. For example, a user can illustrate a “through” pass by selecting the possession vector 125 of the athletic equipment 125 and the movement vector of the team player 111b to be in the same position in the next stage. In some embodiments, the possession vector 125 can change to the new position of the team player 111b when a movement vector of the team player 111b is added to a particular stage.

In the illustrative embodiment of FIGS. 1-2, the user establishes a possession vector 125 for the athletic equipment 115 between the team player 111a and team player 111b. The user also establishes a movement vector 121 for the team player 111a. In some embodiments, both the movement vector 121 and the possession vector 125 occur between the same two stages. In such instances, the team player 111a traverses the movement vector 121 while the athletic equipment 115 traverses the possession vector. In certain embodiments, the user establishes three stages for the simulated athletic play. In such an instance, the athletic equipment 115 traverses the possession vector 125 between the first and second stages, while the team player 111a traverses the movement vector between the second and third stages. In some embodiments, the user can pause the playback of transition between the stages and can modify the movement vector 121 of the team player 111, or can add a movement vector for another player, such as opponent player 113a. In such instances, the simulation platform 101 can add a new stage that saves the position of the players 111a-111b, 113a-113b and the athletic equipment 115 and the associated movement and possession vectors at the stage where the play is paused.

Control panel 105 can include one or more controls used by the user to create or modify particular stages in a set play. The control panel 105 can include control buttons or menus that can add new stages to a simulated athletic play, playback the athletic play, and pause the athletic play during playback. The control panel 105 can also include controls for a specific stage in an athletic play. Controls include buttons to add or remove players on the VPE 103, buttons to add movement and possession vectors, and menus that include specific movement and possession vectors. For example, a control panel for a football VPE can include a multitude of movement vectors that represent different receiving routes (e.g., post pattern, out pattern, curl pattern, etc.) for a receiver. In such instances, the user can select a player 111a-111b, 113a-113b, and assign a specific movement vector selected from the control panel 105.

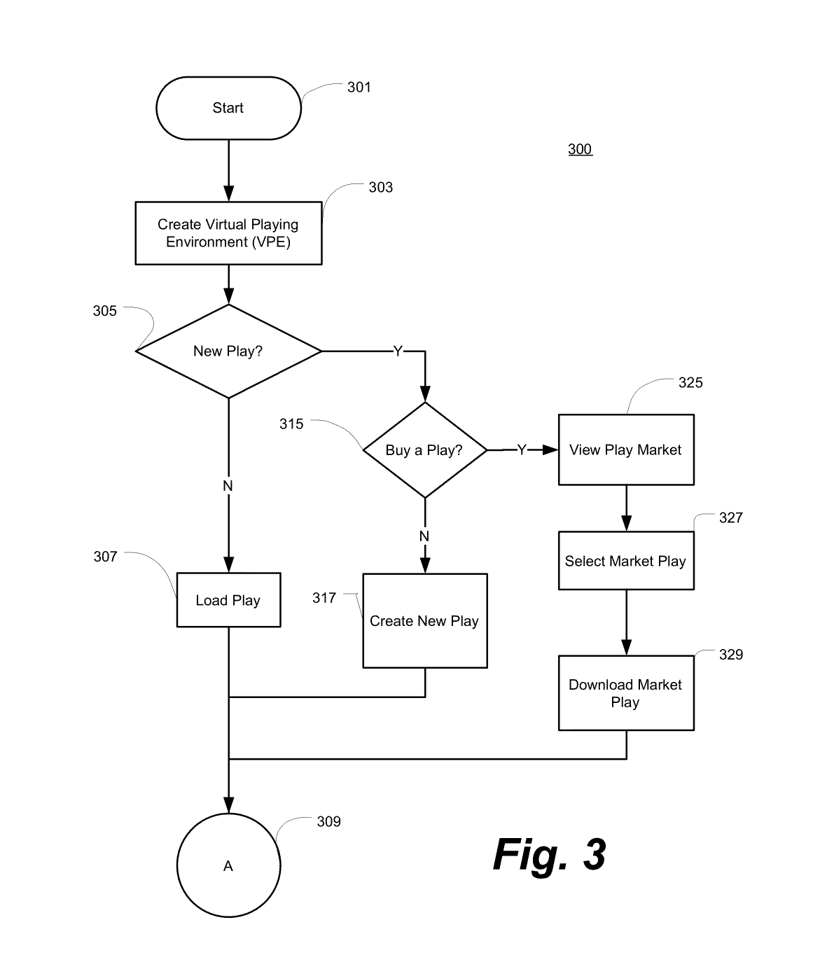

FIG. 3 shows an exemplary flowchart for control of the virtual playing environment. A user can enact method 300, for example, upon startup of the simulation platform 101 on an electronic device, such as a tablet computer, smartphone, browser, or computer program. The simulation platform can begin at step 301 and proceed to step 303 by creating a virtual playing environment (VPE) 103. After the simulation platform 101 creates the VPE 103, the simulation platform proceeds to 305 by asking the user whether to create a new play. When the user responds with a “NO,” the simulation platform in step 307 allows the user to load a saved play. Otherwise, the simulation platform proceeds to step 315 by prompting the user to either buy a play from a playbook marketplace or to create a new play.

Based on the user's choice in step 315, the simulation platform 101 can create a new play in step 317. Alternatively, the simulation platform 101 can, in step 325, display the playbook marketplace for the user to view. In step 327, the user selects a specific play from those displayed in the playbook marketplace. The simulation platform downloads the user-selected play from the marketplace in step 329. In some embodiments, a play from the playbook marketplace or a saved play can also have an associated video (e.g., a live-action video) that can be viewed in conjunction with loading the desired play.

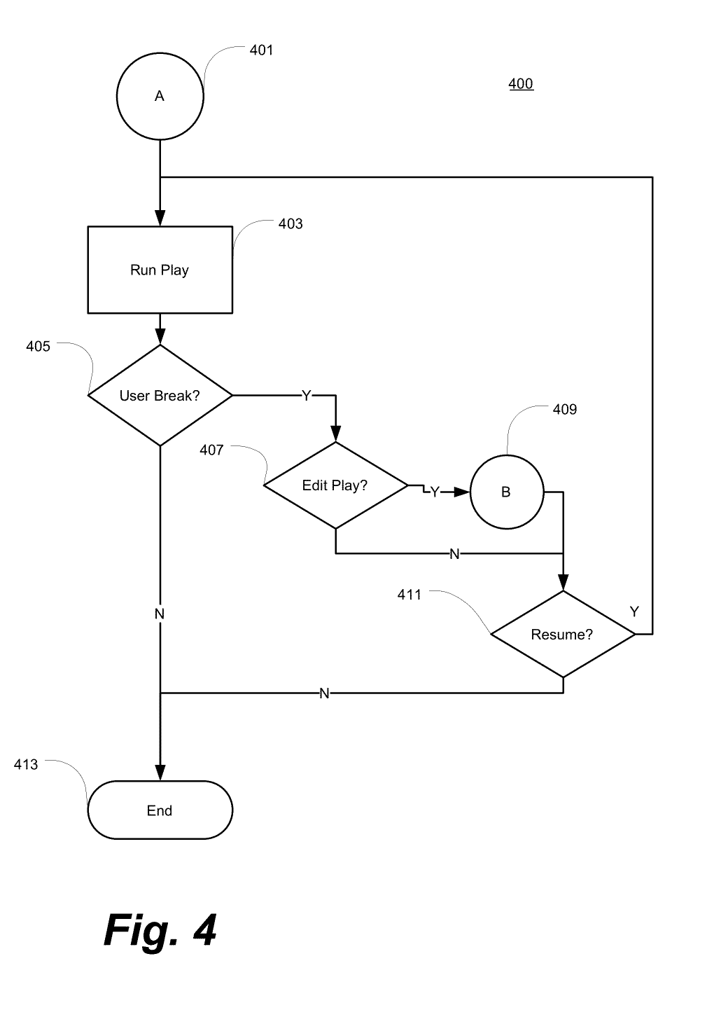

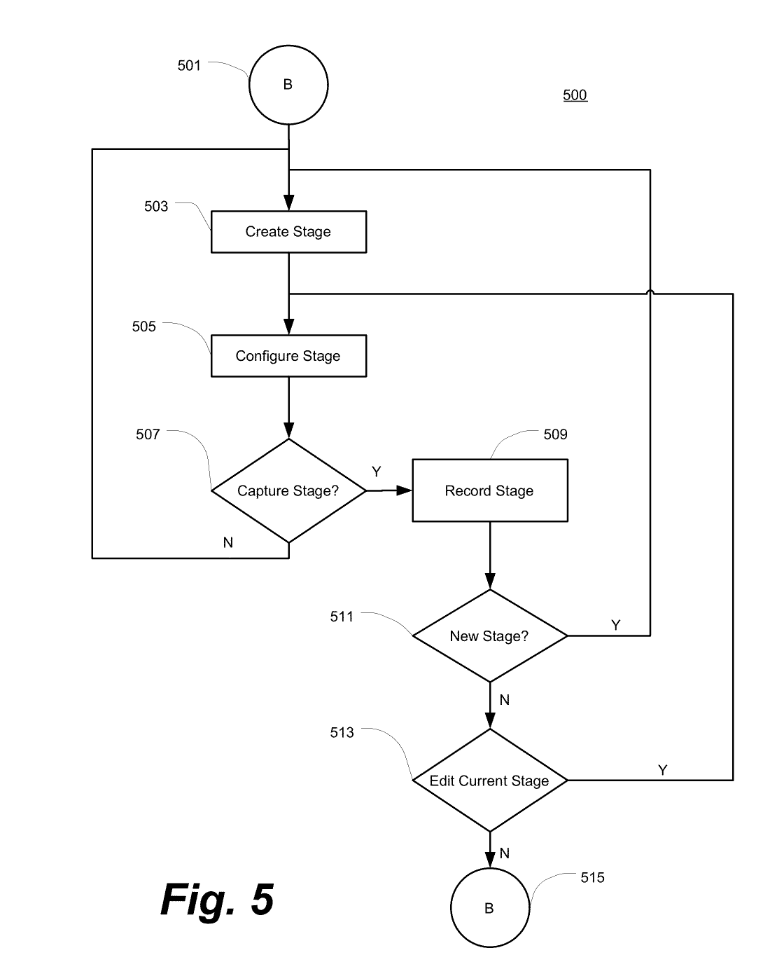

Whether the simulation platform has loaded a play in step 307, created a new play in step 317, or downloaded a play in step 329, the simulation platform proceeds to step 309, which begins method 400 as illustrated in FIG. 4. Simulation platform 101 cannot enact method 400 to enable playback and editing of a specific athletic play. Simulation platform 101 may begin method 400 by proceeding from method 300 in step 401 and then proceeding to step 402, where it prompts the user to either run or edit the play. When the user decides to edit a play, the simulation platform may proceed to step 409, where it enacts method 500 as illustrated in FIG. 5, as will be discussed in further detail below.

When the user decides to run a play, the simulation platform 101 proceeds from step 402 to step 403 and animates the stages included in the loaded play. In step 403, the simulation platform 101 animates the transitions between the various stages of the loaded play, animating the players and athletic equipment as they traverse along their respective movement and possession vectors 121, 125. In some embodiments, the simulation platform 101 uses specific attributes associated with the players 111a-111b, 113a-113b, athletic equipment 115, and the vectors 121, 125 when animating the play. For example, a user can associate specific characteristics such as weight, strength, acceleration, agility, and speed to a specific player. These attributes can, for example, alter the speed at which the player 111a traverses the movement vector and can also affect the probability that the player 111a traverses the movement vector successfully. Similarly, other attributes assigned to players, such as accuracy, passing skills, offensive and defensive awareness, and stealing ability, can affect the possession vector of the athletic equipment and whether a specific pass or shot is successful. If the no user break, as in step 405, occurs, the simulation platform 403 can run the entire play by animating all the stages. When the final stage is reached, the simulation platform may end method 400 by proceeding to step 413. In some embodiments, the simulation platform 101 can playback a video associated with the loaded play. In some embodiments, method 400 can present a step prior to step 403 (not shown) for the user to decide whether to play the associated video or animate the play in step 403.

During step 403, the user can start a user break 405. The user can select a pause command in the control panel 105, or the break can occur when the user selects one of the players 111a-111b, 113a-113b, or the athletic equipment and changes the respective positioning or vector. When the user break occurs at 105, the simulation platform 101, in step 407, confirms whether the user wishes to edit the play. If so, the simulation platform proceeds to step 409 to enact method 500 of FIG. 5. Otherwise, the simulation platform in step 411 prompts the user to resume the play from the point of the user break. In some embodiments, the user at 411 can restart the play from the beginning. In some embodiments, the user can choose to play a video associated with the play. If the user chooses to resume the play, the simulation platform 101 proceeds to step 403 from the point that the user break occurred. Otherwise, the simulation platform 101 ends the method 400 at step 413.

FIG. 5 shows the method 500 of editing a loaded athletic play. The simulation platform 101 can enact method 500 when a user decides to edit a play. The user can decide to edit a play before running the play, as illustrated in step 402, or when the user causes a user break in step 405 and decides to edit the play. In some embodiments, the user can also associate video with the loaded athletic play. In some embodiments, the user can associate locally-saved existing video (e.g., video captured on the touchscreen device), or download existing video. In some embodiments, the simulation platform 101 can enable the user to use third-party video capture hardware and/or software to capture video, which would subsequently be associated with the loaded athletic play. Simulation platform 101 can enact method 500 by beginning at step 501, which is the same step as step 409 in method 400. From step 501, the simulation platform 101 begins the editing by creating a stage. In some embodiments, creating the stage involves resetting the positioning and vectors to the beginning of a particular stage. When creating a new play, as the players 111a-111b, 113a-113b can be positioned in a first stage (stage 1) without any movement vectors. In some embodiments, each stage can have an associated video.

The create stage step of step 503 can involve the simulation platform 101 creating a new stage between two previously-established stages. For example, when the user decides to edit the play by pausing between stages, the players can be in positions between their positioning in the first stage (stage 1) and the next stage (stage 2). In such an instance, the simulation platform 101 can create an intermediate stage (stage 3) between the first and next stages, such that the play, when resumed, runs from stages 1 to 3 to 2. In such instances, the positioning and movement vectors can be split so that the final positioning in stage 2 remains the same.

In step 505, the simulation platform 505 allows the user to configure the specific stage. The user can add, remove, and position players 111a-111b, 113a-113b in a specific stage, change possession of the athletic equipment 115, and configure movement and possession vectors 121, 125 for the respective players and athletic equipment within the stage. For instance, following the previous example, the user changes the components in stage 3, including the positioning of the players 111a-111b, 113a-113b, possession of the athletic equipment 115, and the vectors 121, 125. The simulation platform can reconfigure the associated positioning and vectors for the previous (stage 1) and subsequent (stages 2) to reflect the user changes.

Once the configuration is complete, the simulation platform 101, in step 507, prompts the user to capture the stage. If the user chooses “NO,” the simulation platform 101 returns to step 505. When the user in step 507 chooses to capture the stage, the simulation platform 101 proceeds to step 509. The stage is recorded as part of a saved play. In some embodiments, the user can opt for the simulation platform 101 to automatically save the play and record the stage whenever the user reconfigures a stage.

Once the stage is recorded, the simulation platform 101, in step 511, asks the user whether to change to a different stage. If the user chooses “NO,” the simulation platform 101 proceeds to step 513 to ask the user whether to continue to edit the current stage. If the user again chooses “NO,” method 500 ends and can proceed, for example to step 411 of method 400. If the user, in step 513, instead chooses to edit the current stage, the simulation platform 101 returns to step 505 to allow the user to configure the current stage. Similarly, when the user, in step 511, chooses to change to a different stage, the simulation platform returns to step 503 to create a stage. In some embodiments, the simulation platform 101, in step 503, moves to an already-created stage. For example, the user can choose, in step 511, to move from stage 3 to (the existing) stage 1 of the play. In this instance, the simulation platform 101 in step 503 transitions to the existing stage 1 of the play.

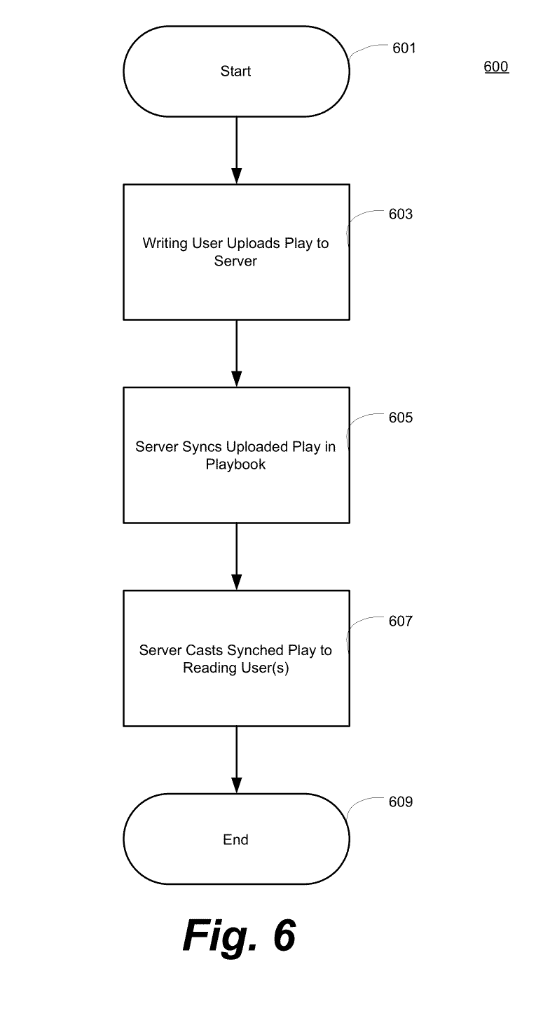

FIG. 6 shows method 600 for the simulation platform to share plays via a server. The simulation platform 101 can enact method 600 as soon as a play is saved. For example, in some embodiments, the simulation platform 101 automatically enacts method 600 every time a play is saved, such as in step 509 of method 500. Simulation platform 101 starts method 600 at step 601 and proceeds to step 603, where the writing user (i.e., the user configuring the play) uploads a saved play to a server. For example, the server can receive the play as an .xml file that includes the positioning, vector, and attribute data associated with the saved play as text. In some embodiments, the server can also receive video associated with the play. In some embodiments, the server is a secure server that receives the play as a specific configuration file. In some embodiments, the server can be a cloud server that can be controlled by the writing user.

In step 605, the server syncs to play uploaded in step 603 with other plays in the writing user's playbook. In some embodiments, the server can add the newly-uploaded play and video to the writing user's playbook, which can act as folder containing a set of saved plays and videos. In some embodiments, the server overwrites a saved play in the playbook with the uploaded play whenever syncing occurs. Thus, when the user allows the play to automatically saved whenever the user reconfigures a stage, the server, in step 605, can enable real-time syncing of plays as they are edited.

The server, in step 607, casts the synced play or playbook to reading users. The reading users can include other users with writing capabilities. The reading users can also include users that do not have writing capabilities, or users on electronic devices that do not have editing tools. The server can send the play synced in step 605 to authorized reading users' devices via casting methods, such as unicast, multicast, and similar methods of transferring the synced play. Once the server casts the synced play, it can proceed to step 609 to end method 600.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., plasma display or LCD (liquid crystal display), for displaying information to the user, and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, and/or other communication protocols.

Devices of the computing system can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation). Mobile computing device include, for example, a Blackberry®. IP phones include, for example, a Cisco® Unified IP Phone 7985G available from Cisco Systems, Inc, and/or a Cisco® Unified Wireless Phone 7920 available from Cisco Systems, Inc.

While the technology has been particularly shown and described with reference to specific illustrative embodiments, it should be understood that various changes in form and detail may be made without departing from the spirit and scope of the technology.

I claim:

1. A method, executed on a simulation platform, of representing an athletic play, the method comprising:
producing, by the simulation platform, a simulated athletic play representing the athletic play, the producing step comprising:
receiving an inputted information representing the athletic play created by a user,
producing, based on the received inputted information, a first stage comprising a first virtual athlete in a virtual playing environment,
positioning the first virtual athlete within the virtual playing environment during the first stage,
producing a second stage comprising the virtual athlete in the virtual playing environment, and
creating a first movement vector representing a change in position of the first virtual athlete between the first stage and the second stage.

2. The method of claim 1, further comprising:
playing, by the simulation platform, the simulated athletic play, wherein the first virtual athlete position moves along the first movement vector between the first and second stage;
pausing, by the simulation platform, the simulated athletic play during the playing step; and
changing, by the simulation platform, the first movement vector of the first virtual athlete.

3. The method of claim 2, further comprising:
producing, after the pausing step, a third stage comprising the first virtual athlete in the virtual playing environment, wherein the position of the first virtual athlete in the third stage comprises the position of the first virtual athlete after the pausing step and further wherein the changing step comprises changing the first movement vector to represent the change in position of the first virtual athlete between the first stage and the third stage; and
producing a second movement vector, wherein the second movement vector represents the change in position of the first virtual athlete between the third stage and the second stage.

4. The method of claim 1, further comprising:
saving the simulated athletic play.

5. The method of claim 4, further comprising:
uploading, the simulation platform, the saved simulated athletic play to a server.

6. The method of claim 5, wherein the server transmits the saved simulated athletic play to at least one other authorized electronic device.

7. The method of claim 6, further comprising:
playing, by the simulation platform, the simulated athletic play, wherein the first virtual athlete position moves along the first movement vector between the first and second stage;
pausing, by the simulation platform, the simulated athletic play during the playing step; and
changing, by the simulation platform, the first movement vector of the virtual athlete.

8. The method of claim 7, wherein the saving step and the uploading step occur every time the changing step occurs.

9. The method of claim 6, wherein the at least one other authorized electronic device plays the saved simulated athletic play.

10. The method of claim 7, wherein the at least one other authorized electronic device plays the saved simulated athletic play.

11. The method of claim 10, wherein the playing step on the at least one other authorized electronic device occurs without the ability to perform the changing step.

12. The method of claim 2, wherein the playing step comprises producing an animation of the at least one virtual athlete traversing the first movement vector.

13. The method of claim 1, wherein the creating a simulated athletic play step further comprises:
producing a second virtual athlete in the virtual playing environment.

14. The method of claim 13, wherein the producing a first stage step further comprises the producing a second virtual athlete step.

15. The method of claim 13, wherein the creating a simulated athletic play step further comprises:
establishing, possession of athletic equipment by the first virtual athlete or the second virtual athlete in the first stage; and
creating a possession vector for the athletic equipment.

16. The method of claim 1, wherein the first movement vector is based upon at least one performance metric associated with the first virtual athlete.

17. The method of claim 16, wherein the possession vector is based upon at least one performance metric associated with the first virtual athlete.

18. The method of claim 1, wherein the creating a simulated athletic play step further comprises:
producing a first opponent virtual athlete.

19. The method of claim 1, wherein the inputted information comprises data created through the usage of an input/output terminal associated with the simulation platform.

20. The method of claim 19, wherein the input/output terminal comprises a touch-sensitive screen.
